(19) United States
(12) Patent Application Publication
(10) Pub. No.: US 2021/0383213 A1
(43) Pub. Date: Dec. 9, 2021

(54) PREDICTION DEVICE, PREDICTION METHOD, COMPUTER PROGRAM PRODUCT, AND VEHICLE CONTROL SYSTEM

(71) Applicant: KABUSHIKI KAISHA TOSHIBA, Tokyo (JP)

(72) Inventor: Atsushi KAWASAKI, Yokohama (JP)

(73) Assignee: KABUSHIKI KAISHA TOSHIBA, Tokyo (JP)

(21) Appl. No.: 17/182,282

(22) Filed: Feb. 23, 2021

(30) Foreign Application Priority Data
Jun. 9, 2020 (JP) 2020-100107

(51) Int. Cl. G06N 3/08; G06N 3/04

(52) U.S. Cl. CPC G06N 3/08; G06N 3/04

(57) ABSTRACT

A prediction device according to an embodiment includes one or more hardware processors. The hardware processors acquire moving object information indicating the positions of one or more moving objects including a first moving object to be predicted. The hardware processors generate cumulative map information expressing, on a map, a plurality of positions indicated by the moving object information acquired at a plurality of first time points equal to or earlier than the reference time point. The hardware processors predict a position of the first moving object at a second time point later than the reference time point based on environment map information expressing, on a map, an environment around the first moving object at the reference time point, moving object information acquired at the reference time point, and the cumulative map information.

### CROSS-REFERENCE TO RELATED APPLICATIONS

This application is based upon and claims the benefit of priority from Japanese Patent Application No. 2020-100107, filed on Jun. 9, 2020; the entire contents of which are incorporated herein by reference.

### FIELD

Embodiments described herein generally relate to a prediction device, a prediction method, a computer program product, and a vehicle control system.

### BACKGROUND

In order to realize safe and comfortable autonomous driving and driving support of automobiles and autonomous movement of robots, there is a need to grasp not only stationary obstacles such as buildings, fences, and curbs, but also the movements of moving objects such as other vehicles and pedestrians beforehand. In scenes such as changing lanes and crossing intersections in particular, unless predicting how moving objects will move in the future, the safe behavior of an own vehicle is not determinable.

A prediction technique capable of predicting future positions of a moving object with higher accuracy is in demand.

### BRIEF DESCRIPTION OF THE DRAWINGS

FIG. 1 is a view illustrating a vehicle according to an embodiment;

FIG. 2 is a hardware configuration diagram of a processing apparatus;

FIG. 3 is a view illustrating an example of predicting a trajectory in accordance with map information prepared in advance;

FIG. 4 is a diagram illustrating an example of predicting a trajectory using sensor information alone;

FIG. 5 is a functional block diagram of a prediction device;

FIG. 6 is a diagram illustrating an outline of a trajectory prediction process;

FIG. 7 is a functional block diagram of an environment map generator;

FIG. 8 is diagram illustrating an example of an obstacle map;

FIG. 9 is a diagram illustrating an example of a cumulative map generated;

FIG. 10 is a functional block diagram of a predictor;

FIG. 11 is a diagram illustrating an example of normalization of map information;

FIG. 12 is a functional block diagram of the predictor;

FIG. 13 is a flowchart of a prediction process; and

FIG. 14 is a flowchart of a learning process.

### DETAILED DESCRIPTION

A prediction device according to an embodiment includes one or more hardware processors. The hardware processors acquire moving object information indicating the positions of one or more moving objects including a first moving object to be predicted. The hardware processors generate cumulative map information expressing, on a map, a plurality of positions indicated by the moving object information acquired at a plurality of first time points equal to or earlier than the reference time point. The hardware processors predict a position of the first moving object at a second time point later than the reference time point based on environment map information expressing, on a map, an environment around the first moving object at the reference time point, moving object information acquired at the reference time point, and the cumulative map information.

Preferred embodiments of a prediction device will be described in detail below with reference to the accompanying drawings.

Prediction techniques adapted for predicting future positions of moving objects in the surroundings have been examined in the past. In order to make a prediction with higher stability, there has been proposed a method of making a prediction using a high-precision map and an aerial photographic image including information such as a lane center line as environmental information. However, such map information needs to be prepared in advance, and preparing the map information for all roads would not be practical. In addition, generating a high-precision map would need a large processing load and cost.

In view of this, there has been a demand for a technique capable of predicting the position of other moving objects existing in the surroundings by using information obtained from sensors such as cameras and laser sensors attached to moving objects (automobiles, autonomous mobile robots, or the like) alone without using map information prepared in advance.

In addition, in order to make robust predictions in a wide variety of scenes, there have been proposed techniques of performing data collection and learning for each of the scenes. Unfortunately, however, these techniques need a server and storage for data collection. Therefore, there is a demand for a technique capable of achieving general purpose application just by one round of learning.

A prediction device according to the present embodiment generates an environment map (environment map information) and a cumulative map (cumulative map information) as map information only from the information obtained from the sensor without preparing the map information in advance, and predicts future position of the moving object using the generated map information. The cumulative map includes map information indicating areas having high probability of passage of a plurality of moving objects that can include a moving object other than the moving object as a target of position prediction. This makes it possible to make robust predictions even in locations with no map information or locations visited for the first time.

The moving object is, for example, a vehicle such as an automobile or a motorbike that moves along a lane provided on a road. The moving object is not limited to an automobile or a motorbike, and may be a robot that moves along a lane, for example. The moving object may be an object moving in a lane on the water, such as a ship. The following description will be given mainly using an exemplary case where the moving object is a vehicle.

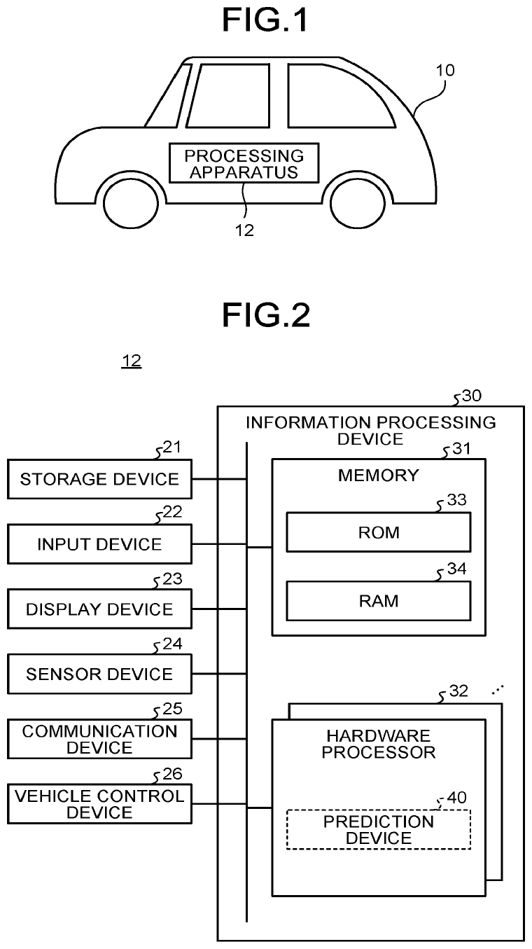

FIG. 1 is a view illustrating a vehicle 10 according to an embodiment. The vehicle 10 is equipped with a processing apparatus 12. The processing apparatus 12 is a device including a dedicated or general-purpose computer, for example. At least a part of the functions of the processing apparatus 12 may be mounted on another device such as a cloud connected to the vehicle 10 via a network, rather than being mounted on the vehicle 10. The vehicle 10 may be an ordinary vehicle that travels by using driving operations by a person, or an autonomous driving vehicle that can automatically travel (autonomously travel) without using driving operation by a person. The processing apparatus 12 is not limited to the vehicle 10, and may be provided in other devices such as roadside devices.

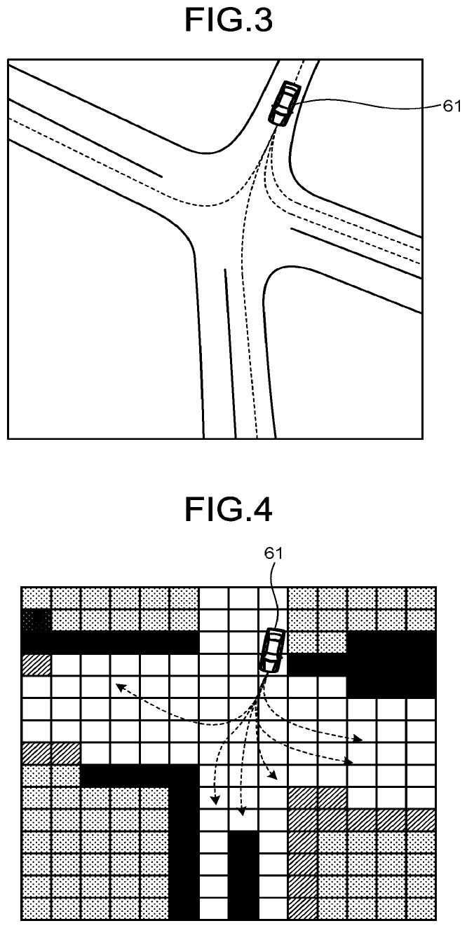

FIG. 2 is a diagram illustrating an example of a hardware configuration of the processing apparatus 12 according to an embodiment. The processing apparatus 12 includes a storage device 21, an input device 22, a display device 23, a sensor device 24, a communication device 25, a vehicle control device 26, and an information processing device 30.

Examples of the storage device 21 include a hard disk drive, an optical disk drive, or a semiconductor memory element such as a flash drive. The storage device 21 stores a program executed by the processing apparatus 12 and data used by the processing apparatus 12.

The input device 22 receives instructions and information input from the user. Examples of the input device 22 include input devices such as an operation panel, a pointing device such as a mouse or a trackball, or a keyboard.

The display device 23 displays various types of information to the user. The display device 23 is, for example, a display device such as a liquid crystal display device.

The sensor device 24 has one or more sensors that detect surrounding conditions of the vehicle 10. For example, the sensor device 24 detects the position, speed, acceleration, angular velocity, and angular acceleration of a moving object (for example, another vehicle) existing around the vehicle 10. Furthermore, the sensor device 24 detects direction instruction information indicating the traveling direction of a moving object existing around the vehicle 10. For example, the sensor device 24 has a distance sensor (laser sensor, LiDAR, or the like) that detects a distance using laser light. The sensor device 24 may have a millimeter wave sensor that detects the position and speed of the moving object. The sensor device 24 may have a sonar that detects the distance to a surrounding object by sound waves. Furthermore, for example, the sensor device 24 may have a camera that captures an image of a surrounding object. The camera may be of any type of camera, such as a monocular camera and a stereo camera.

The communication device 25 transmits/receives information to/from an external device by wireless communication. The communication device 25 acquires detection result such as the position, speed, acceleration, angular velocity, angular acceleration, and direction instruction information of a moving object existing around the vehicle 10, obtained by a sensor provided in an external device (for example, a roadside device) of the vehicle 10. Furthermore, the communication device 25 may directly communicate with the moving object existing around the vehicle 10, for example, by performing vehicle-to-vehicle communication to acquire the position, speed, acceleration, angular velocity, angular acceleration, and direction instruction information of the moving object.

The vehicle control device 26 controls a drive mechanism for driving the vehicle 10. For example, in a case where the vehicle 10 is an autonomous driving vehicle, surrounding situations are determined based on the position of the moving object predicted by a prediction device 40, the information obtained from the sensor device 24, and other information to control the accelerator amount, braking amount, steering angle, or the like. Furthermore, in the case of an ordinary vehicle in which the vehicle 10 travels by using driving operations by a person, the vehicle control device 26 controls the accelerator amount, the braking amount, the steering angle, or the like based on the operation information.

The information processing device 30 is one or more dedicated or general-purpose, computers, for example. The information processing device 30 manages and controls the storage device 21, the input device 22, the display device 23, the sensor device 24, the communication device 25, and the vehicle control device 26. The information processing device 30 has memory 31 and one or more hardware processors 32.

The memory 31 includes Read Only Memory (ROM) 33 and Random Access Memory (RAM) 34. The ROM 33 non-rewritably stores a program used for controlling the information processing device 30, various setting information, or the like. The RAM 34 is a volatile storage medium such as synchronous dynamic random access memory (SDRAM). The RAM 34 functions as a work area for one or more hardware processors 32.

The one or more hardware processors 32 are connected to the memory 31 (ROM 33 and RAM 34) via a bus. The one or more hardware processors 32 may include, for example, one or more Central Processing Units (CPUs), or may include one or more Graphics Processing Units (GPUs). The one or more hardware processors 32 may include a semiconductor device or the like including a dedicated processing circuit for implementation of a neural network.

By executing various processes in cooperation with various programs preliminarily stored in the ROM 33 or the storage device 21 using a predetermined area of the RAM 34 as a work area, the one or more hardware processors 32 functions as the prediction device 40. The information processing device 30 or the processing apparatus 12 can be considered to correspond to the prediction device 40. Details of the function of the prediction device 40 will be described below.

The program to function as the prediction device 40 may be recorded in a file in an installable or executable format, on a computer readable recording medium such as a Compact Disk Read Only Memory (CD-ROM), a flexible disk (FD), a Compact Disk Recordable (CD-R), or a Digital Versatile Disk (DVD) and may be provided as a computer program product.

Moreover, the program may be stored on a computer connected to a network such as the Internet and provided by being downloaded via the network. Moreover, the program may be provided or distributed via a network such as the Internet.

Here, an example of map information will be described. FIG. 3 is a view illustrating an example of predicting the trajectory of a vehicle (an example of a moving object) based on map information prepared in advance including lane information. FIG. 4 is a diagram illustrating an example of predicting the trajectory by using only the information (sensor information) from the sensor device 24 without using the map information prepared in advance. The lane information is information indicating a trajectory on which the moving object is to travel. The trajectory is information indicating the positions of moving objects at a plurality of time points.

As illustrated in FIG. 3, a moving object 61 generally moves along a lane (broken line). Therefore, in the trajectory prediction using map information prepared in advance, the action range of the moving object 61 can be narrowed down, even with occurrences of the acceleration/deceleration and the lane selection problems.

An example of map information that can be used when only sensor information is used is an obstacle map illustrating the presence or absence of obstacles in a grid pattern. FIG. 4 illustrates an example of such an obstacle map. For example, a grid with no obstacles is illustrated in white, a grid with obstacles is illustrated in black, and a grid in which the presence of obstacles is unknown is illustrated in gray. In the trajectory prediction using the obstacle map as illustrated in FIG. 4, it is obvious that the moving object 61 moves in areas where there is no obstacle (white area). However, it is difficult to narrow down the area the moving object 61 should pass (arrows) since the range of action can be wide, leading to unstable prediction.

To handle this, the present embodiment generates and uses a cumulative map as map information that assists the obstacle map. Hereinafter, details of the functions of the prediction device 40 of the present embodiment will be described.

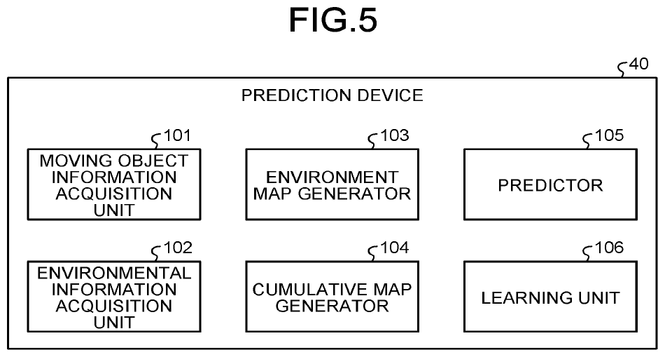

FIG. 5 is a block diagram illustrating a functional configuration example of the prediction device 40 according to the present embodiment. As illustrated in FIG. 5, the prediction device 40 includes a moving object information acquisition unit 101, an environmental information acquisition unit 102, an environment map generator 103, a cumulative map generator 104, a predictor 105, and a learning unit 106.

The moving object information acquisition unit 101 acquires moving object information indicating the positions of one or more moving objects including a moving object to be predicted (first moving object). For example, the moving object information acquisition unit 101 acquires moving object information by using the sensor device 24, vehicle-to-vehicle communication, road-to-vehicle communication, or the like. Road-to-vehicle communication is communication between an external device such as a roadside device and the vehicle 10. The method of acquiring the moving object information is not limited to this, and any method may be used.

The moving object information may further include at least one of the orientation (angle, etc.), speed, acceleration, angular velocity, angular acceleration, variance of each of these values (direction, velocity, acceleration, angular velocity, and angular acceleration), the direction of movement (direction indicator information or the like), and identification information (such as object ID) of the moving object.

The environmental information acquisition unit 102 acquires environmental information. For example, the environmental information acquisition unit 102 acquires environmental information using only the information obtained from the sensor device 24. The environmental information is information indicating the environment surrounding the moving object to be predicted. For example, environmental information includes at least one of an obstacle, a road, a walking path, a curb, a sign, a traffic light, and road marking. An obstacle represents an object around the moving object.

For example, by detecting the distance to an object around the moving object by using a distance sensor, the environmental information acquisition unit 102 acquires position information of this object (obstacle) as environmental information. Information such as roads, walking paths, curbs, signs, traffic lights, and road markings can be acquired using techniques such as object detection and semantic segmentation using images captured by cameras, for example.

The environmental information acquisition unit 102 may acquire environmental information by combining a plurality of methods. For example, in addition to detecting an obstacle by using a distance sensor, it is allowable to further detect the type of object detected as an obstacle by using a technique such as object detection using an image captured by a camera, semantic segmentation, or the like.

The environment map generator 103 generates an environment map. The environment map includes map information expressing, on a map, an environment around the moving object at a reference time point. For example, the environment map generator 103 generates an environment map using the moving object information and the environmental information at the reference time point.

An example of the reference time point is a current time point. The reference time point may be a time point earlier than the current time point. For example, the prediction process can be evaluated by comparing the trajectory of the moving object predicted with a time point earlier than the current time point, as the reference time point, with an actual trajectory (trajectory up to the current time point or the like). Details of the function of the environment map generator 103 will be described below.

The cumulative map generator 104 generates a cumulative map. The cumulative map includes map information expressing, on a map, a plurality of positions indicated by the moving object information acquired at a plurality of time points (first time point) equal to or earlier than the reference time point. In this manner, the cumulative map is generated so as to cumulatively store, on the map, not only the position at the reference time point but also the positions indicated by the moving object information acquired earlier than the reference time.

For example, a value (for example, “1”) indicating the presence of a moving object is set in a grid corresponding to the position where a moving object is present at any of a plurality of time points. A value (for example, “0”) indicating the absence of a moving object is set in a grid corresponding to the position where no moving object is present at any time point.

Furthermore, for the cumulative map, at least one of the movement amount, speed, and movement direction of the moving object is associated with each of the positions (grids). The movement amount, the speed, and the direction of movement may be represented by a mixture distribution. Details of the function of the cumulative map generator 104 will be described below.

The predictor 105 predicts the future position of the moving object from the moving object information, the environment map, and the cumulative map, and outputs a predicted trajectory of the moving object. The future position may be represented by the coordinates of the position, or may be represented, for example, by the movement amount from the current position. For example, the predictor 105 predicts the position of the moving object based on the environment map at the reference time point and the cumulative map that has accumulated the moving object information acquired at the reference time point and the moving object information acquired up to the reference time point. The predictor 105 predicts the position of the moving object by using a model such as a neural network that inputs an environment map and moving object information, and a cumulative map, and outputs a prediction result of the position of the moving object, for example.

The number of moving objects to be predicted is not limited to one, and may be in plurality. The predictor 105 predicts and outputs a trajectory of each of one or more moving objects to be predicted. The predictor 105 may be assigned to each of one or more moving objects, and each of the predictor 105 may predict the trajectory of the corresponding moving object. The moving object to be predicted may be the vehicle 10 itself. For example, the moving object information acquisition unit 101 acquires the moving object information of the vehicle 10 itself by vehicle-to-vehicle communication, road-to-vehicle communication, or the like.

The learning unit 106 provides learning to be applied to the model (neural network) used by the predictor 105. The learning unit 106 may have a function of applying learning to the neural network (details will be described below) used by the environment map generator 103. In the case of using a model and a neural network that have undergone learning in advance, the prediction device 40 does not have to include the learning unit 106. The details of a learning process provided by the learning unit 106 will be described below.

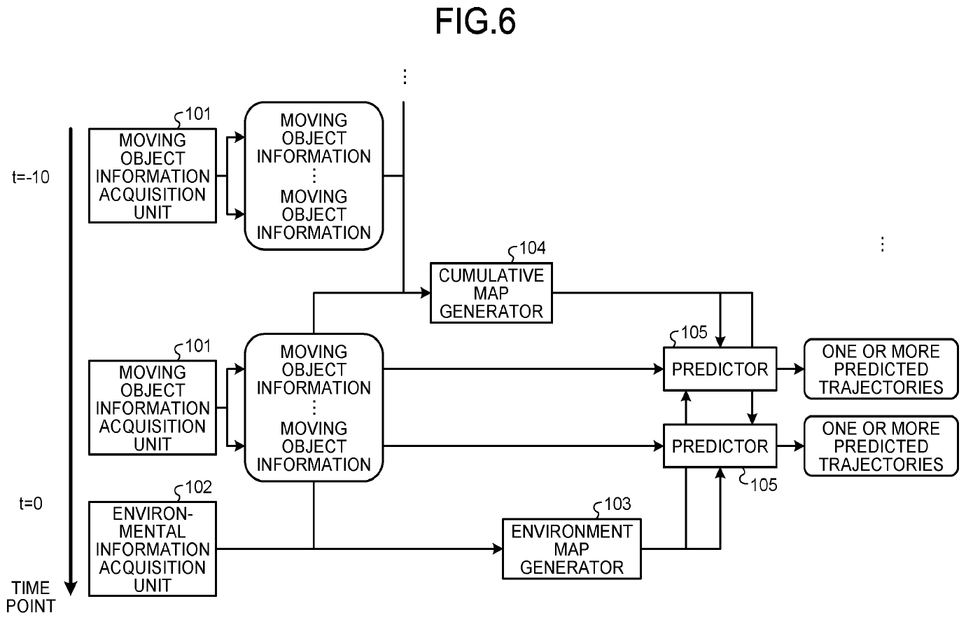

Next, an outline of a trajectory prediction process performed by the prediction device 40 will be described. FIG. 6 is a diagram illustrating an outline of the trajectory prediction process. As illustrated in FIG. 6, the cumulative map generator 104 generates a cumulative map based on a plurality of pieces of moving object information acquired at a time point (t=−10) earlier than the reference time point (t=0) and a plurality of pieces of moving object information acquired at the reference time point. On the other hand, the environment map generator 103 generates an environment map based on the environmental information acquired at the reference time point.

As illustrated in FIG. 6, when a plurality of pieces of moving object information is acquired at the reference time point, the predictor 105 predicts a future trajectory for each of the plurality of moving objects corresponding to the plurality of pieces of moving object information, and outputs one or more predicted trajectories as a prediction result.

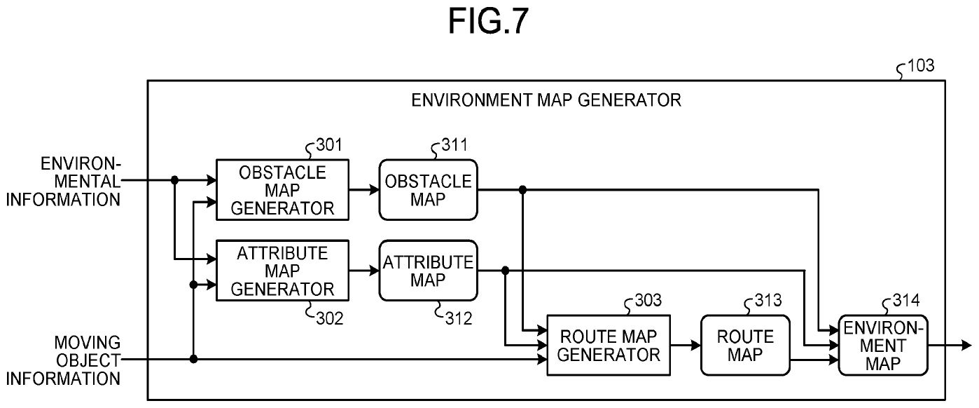

Next, details of the function of the environment map generator 103 will be described. FIG. 7 is a block diagram illustrating a detailed functional configuration example of the environment map generator 103. As illustrated in FIG. 7, the environment map generator 103 includes an obstacle map generator 301, an attribute map generator 302, and a route map generator 303.

The obstacle map generator 301 inputs the environmental information acquired by the environmental information acquisition unit 102 and the moving object information acquired by the moving object information acquisition unit 101, and then generates an obstacle map 311. The attribute map generator 302 generates an attribute map 312 indicating attributes of the environment around the moving object. The route map generator 303 generates a route map 313 indicating a route on which the moving object is to travel.

The environment map generator 103 generates an environment map 314 that integrates an obstacle map, an attribute map, and a route map. The environment map generator 103 may generate one of the obstacle map, the attribute map, and the route map as an environment map, or may generate a map information integrating two of the obstacle map, the attribute map, and the route map, as an environment map. In this case, the environment map generator 103 does not have to include the components unnecessary for the generation of the environment map, out of the obstacle map generator 301, the attribute map generator 302, and the route map generator 303.

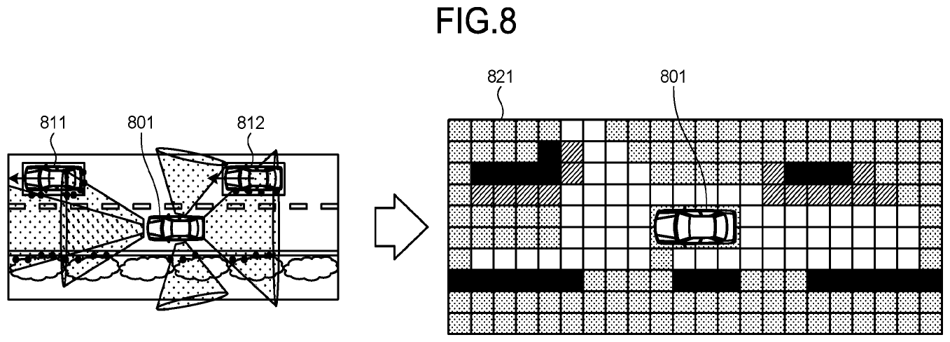

FIG. 8 is a diagram illustrating an example of an obstacle map. FIG. 8 illustrates an example of an obstacle map 821 generated for road conditions as illustrated on the left. In the road condition illustrated in the example of FIG. 8, vehicles 811 and 812 being other moving objects exist around a vehicle 801 corresponding to the vehicle 10.

The obstacle map 821 includes map information indicating the presence or absence of obstacles when observed from above the vehicle 801 using a plurality of grids. Each of the grids is associated with information that expresses the presence or absence of obstacles with a probability value of 0 to 1. In the obstacle map 821, a grid with no obstacles is illustrated in white (probability=0), a grid with obstacles is illustrated in black (probability=1), and a grid in which the presence of obstacles is unknown is illustrated in gray having density corresponding to the probability.

For example, when a light beam (laser light, or the like) has been emitted around the vehicle 10, a grid corresponding to the object (moving object or obstacle) at which the light beam has arrived is set to 1 (with an obstacle); while a grid with no object corresponding to the space between the vehicle 10 and the object is set to 0 (no obstacles). In a case where the light beam does not reach any object, a grid through which the light beam passes is set to 0.5 (unknown), for example.

The obstacle map generator 301 may generate an obstacle map so as to include ambiguity in the position where the obstacle exists. For example, the presence or absence of an obstacle may be represented by a probability distribution centered on a grid in which an object exists. Furthermore, the obstacle map generator 301 may generate an obstacle map indicating the presence/absence of only an object excluding the moving object to be predicted.

Map information including the attribute map, route map, environment map, and cumulative map, which will be described below, is represented in a grid-like format similar to the obstacle map. The size (resolution) and shape of the grid need not be the same between individual pieces of map information, and may be different from each other. When a plurality of pieces of map information having different grid sizes and shapes are integrated (combined), they will preferably be integrated after being converted so that the grid sizes and shapes match.

The attribute map generator 302 generates, for example, an attribute map illustrating attributes for each of grids. For example, from environmental information such as roads, walking paths, curbs, signs, signal lights, and road markings extracted from images captured by the camera, the attribute map generator 302 generates an attribute map indicating which of these objects corresponds to the grid.

Each of the grids of the attribute map is represented by information in a plurality of dimensions. Each of the dimensions indicates the extracted attribute. The representation format of the attribute may be any format. For example, the attribute information may be expressed in a one-hot expression in which only one dimension is 1 and the rest is 0 among a plurality of dimensions. The likelihood of the corresponding attribute obtained by semantic segmentation may be set for each of the plurality of dimensions.

The route map generator 303 generates a route map using a neural network, for example. The route map includes map information containing either a reward map or a policy map. The reward map includes map information illustrating a reward for an action that a moving object is to take. For example, a reward map includes map information in a format in which a scalar value indicating a reward for the presence of a moving object is set for each of grids. The policy map includes map information illustrating a policy that the moving object is to take based on the reward.

The reward map is calculated by a neural network having at least one of an obstacle map and an attribute map as an input, for example. For example, this neural network includes a Convolutional Neural Network (CNN) that inputs at least one of an obstacle map and an attribute map and outputs a reward map.

The neural network for generating the reward map undergoes learning in accordance with inverse reinforcement learning, imitation learning, or the like. An example of behavioral expert data required for the training data is an instructed route for the moving object. Rather than representing the movement amount taken in each of time steps, the route represents time-series data indicating in which order the four actions of move one cell up, move one cell down, move one cell left, and move one cell right, on a map on the grid, have been selected. A stop operation may or need not be added to the actions.

The policy map can be generated based on the reward map. The policy map is a route obtained by selecting the action so as to achieve a high reward, starting from the position of each of moving objects at the reference time point. The policy map may demonstrate one or more policies that can be (are to be) taken by each of the moving objects. Since it starts from the position of each of moving objects, the policy map is generated for each of the moving objects. Accordingly, a route map based on the policy map is also generated for each of the moving objects.

The environment map generator 103 generates an environment map by concatenating at least one piece of map information out of the obstacle map, the attribute map, and the route map generated as described above in a channel direction.

Each of channels corresponds to each of pieces of concatenated map information. In a case where all of the obstacle map, attribute map and route map are concatenated, the number of channels will be three. A value of the map information corresponding to each of channels is set in each of grids of the environment map. When the resolution of the grid of each of pieces of map information differs from each other, the environment map generator 103 first performs conversion to match resolutions and then concatenates each of pieces of map information.

When the route map is generated for each of moving objects, the environment map generator 103 generates an environment map for each of the moving objects. The environment map generated for each of the moving objects is transferred to the predictor 105. When the predictor 105 is assigned to each of one or more moving objects, the corresponding environment map is transferred to the predictor 105 corresponding to each of the moving objects.

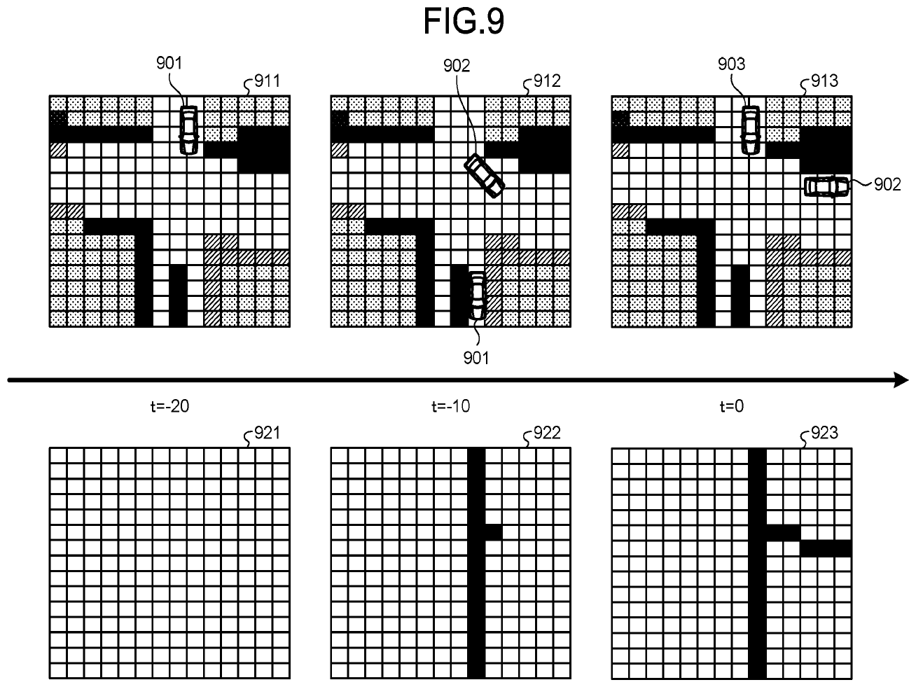

Next, details of the function of the cumulative map generator 104 will be described. FIG. 9 is a diagram illustrating an example of a cumulative map generated by the cumulative map generator 104. FIG. 9 illustrates an example of cumulative maps 921, 922, and 923 generated at time points t=−20, −10, and 0, respectively. At the top of the figure, examples of obstacle maps 911, 912, and 913 generated at each of time points are provided to illustrate the road conditions at each of time points. In the cumulative map of FIG. 9, “1” is set in the grid where the moving object exists, and “0” is set in the grid where the moving object does not exist.

At a time point t=−20, a vehicle 901, which is another moving object, is observed for the first time. The values of individual grids of the cumulative map at this time are all 0.

At a time point t=−10, the vehicle 901 is going straight and a vehicle 902 being another moving object is about to turn left. The cumulative map generator 104 sets “1” in the grid on the cumulative map corresponding to the trajectories of the vehicle 901 and the vehicle 902.

Similarly, at a time point t=0, the cumulative map generator 104 sets “1” in the grid on the cumulative map corresponding to the trajectory of the vehicle 902.

The cumulative map generated in this manner is used for predicting another vehicle 903, which is another moving object, at the reference time point t=0. For example, a grid on which “1” is set in the cumulative map is likely to be an area where the vehicle is recommended to travel. Therefore, by using the cumulative map including such information, it is possible to improve the accuracy of the trajectory prediction of the moving object (vehicle 903).

In the cumulative map of FIG. 9, one channel of information indicating whether a moving object exists is set in the grid. Information of a plurality of channels may be set in each of grids. Each of channels stores, for example, one of the movement amount, speed, and direction (movement direction) of the moving object.

The cumulative map may accumulate multidimensional information or information represented by a mixture distribution for each of channels (movement amount, speed, direction, or the like). For example, it is difficult to hold information such as speed and direction in one dimension because moving objects that make various movements such as going straight and turning left and right intersect each other near the center of an intersection. Therefore, the cumulative map generator 104 compresses the information observed at a plurality of time points into multidimensional information and accumulates the compressed information. The cumulative map generator 104 may compress the information observed at a plurality of time points by expressing it as a multidimensional mixture distribution.

Applicable examples of compression of information include principal component analysis, an EM algorithm, and a recurrent neural network (RNN). For example, the cumulative map generator 104 inputs the information set in the grid and the acquired moving object information into the recurrent neural network, and then sets multidimensional information of a predetermined number of dimensions including the mixture distribution output from the recurrent neural network, as new information for the grid. By compressing and accumulating information, it is possible to reduce the storage capacity required for the cumulative map.

Cumulative maps can only be used in the same area. Therefore, a cumulative map is generated by accumulating information in a predetermined range centered on the vehicle 10. When the vehicle 10 moves, the accumulated information is held by performing coordinate transformation such as moving and rotating the cumulative map according to the movement amount. Similar to the cumulative map, the environment map is also generated centering on the vehicle 10, for example. When a sensor is installed in an external device (for example, a roadside device), an environment map and a cumulative map are generated centering on the mounting position of the sensor.

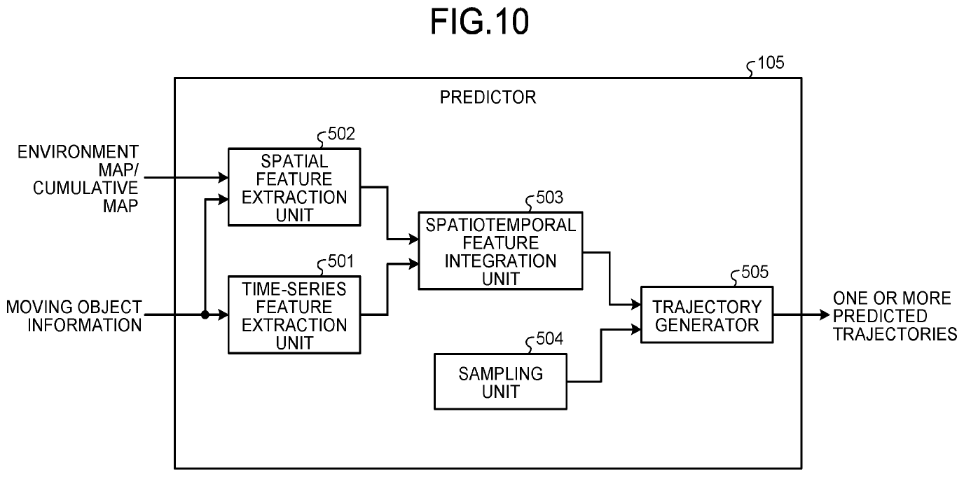

Next, details of the function of the predictor 105 will be described. The predictor 105 behaves differently at the time of inference and learning. FIG. 10 is a block diagram illustrating a detailed functional configuration example of the predictor 105 at the time of inference. As illustrated in FIG. 10, the predictor 105 includes a time-series feature extraction unit 501, a spatial feature extraction unit 502, a spatiotemporal feature integration unit 503, a sampling unit 504, and a trajectory generator 505.

The time-series feature extraction unit 501 extracts time-series features from the moving object information and outputs the time-series features. The time-series feature extraction unit 501 inputs data (input data) as a result of acquisition of a one-dimensional vector for one time point or more including at least one of pieces of moving object information acquired by the moving object information acquisition unit 101, such as position, angle, speed, angular velocity, acceleration, and angular acceleration. The time-series features output by the time-series feature extraction unit 501 are information that characterizes a time-series movement change amount of the moving object.

The time-series feature extraction unit 501 includes a recurrent neural network and a fully connected layer, for example, and repeatedly inputs the above input data. Examples of types of usable recurrent neural network include a simple recurrent network (Simple RNN), Long short term memory (LSTM), and a Gated recurrent unit (GRU).

The spatial feature extraction unit 502 inputs the position and angle that are the moving object information acquired by the moving object information acquisition unit 101, the environment map acquired by the environment map generator 103, and the cumulative map generated by the cumulative map generator 104, as input data, and then outputs spatial features. Spatial features are information that characterizes the surrounding information of a moving object. For example, the spatial feature extraction unit 502 obtains spatial features for the input data by using a neural network that inputs the input data and outputs the spatial features.

The coordinate system of the environment map and the cumulative map is centered on the mounting position of the sensor in the vehicle 10 or in the external device. Therefore, when used as input data for a neural network, the coordinate system needs to be normalized for each of moving objects. That is, the spatial feature extraction unit 502 clips and rotates the environment map and the cumulative map using the position and angle of the moving object information at the reference time point.

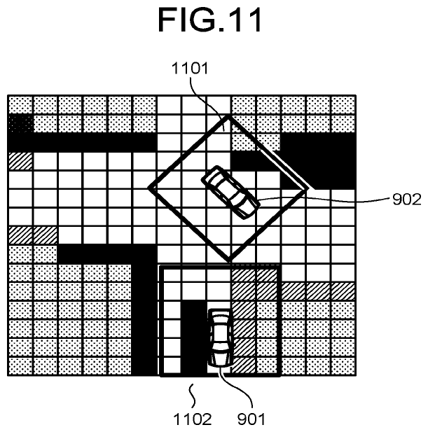

FIG. 11 is a view illustrating an example of normalization of map information for each of moving objects. In FIG. 11, with the vehicles 901 and 902 as the center, clipping and rotation are performed with rectangles each having a predetermined size so that the traveling direction faces upward. The rectangles 1101 and 1102 are examples of map information normalized to vehicles 902 and 901, respectively.

When an area not included in the map information before normalization comes within a range of the map information after normalization, the spatial feature extraction unit 502 may set a predetermined value or a value estimated from a value of a neighboring area, or the like. Setting is performed by putting “0”, “0.5 (unknown in the obstacle map)”, or “1”, for example.

The above normalization method is an example, and is not limited to this. For example, a method of clipping a rectangle only in the front range of the moving object, a method of not performing the rotation process, or the like may be adopted as the normalization method.

The spatial feature extraction unit 502 inputs the normalized environment map and the cumulative map to a neural network. The neural network is constituted with a CNN, for example, and outputs spatial features reduced to a one-dimensional vector. The neural network may be configured to weight (draw attention to) each of grids of the environment map based on the values obtained in the cumulative map. For example, in a case where the speed of the moving object is set for each of grids of the cumulative map, a weight having a value varying with the speed is assigned to the corresponding grid of the environment map. Furthermore, the neural network may be configured to handle the environment map and the cumulative map by concatenating them in the channel direction.

The environment map may include an attribute map detected by semantic segmentation and a route map calculated using a neural network that has undergone learning. Therefore, the environment map might contain incorrect information. In contrast, the cumulative map is generated from actually observed information, and thus is unlikely to contain errors. Therefore, it is possible to improve the prediction accuracy by giving weights to each of grids of the environment map based on the cumulative map or by concatenating the environment map and the cumulative map.

The spatiotemporal feature integration unit 503 inputs the time-series features extracted by the time-series feature extraction unit 501 and the spatial features extracted by the spatial feature extraction unit 502 as input data, and outputs a spatiotemporal feature equivalent to a feature integrating both features. For example, using a neural network that inputs these input data and outputs spatiotemporal features, the spatiotemporal feature integration unit 503 obtains the spatiotemporal feature. Since both the time-series features and the spatial features are one-dimensional vectors, it is possible to use a neural network including a fully connected layer that inputs input data in which these vectors are concatenated in the dimensional direction and outputs the spatiotemporal features.

The sampling unit 504 performs random sampling within a multidimensional normal distribution of one or more dimensions to generate a latent variable of the trajectory. A latent variable is a variable that represents a series of trajectory movements in a multidimensional normal distribution. Latent variables can be considered to be represented by a multidimensional normal distribution that characterizes the trajectory of a moving object. When the trajectory generator 505 outputs a plurality of trajectories, the sampling unit 504 samples a plurality of latent variables. The multidimensional normal distribution representing the latent variable undergoes learning together with the learning applied to the neural network used in the predictor 105. The details of the learning method of the multidimensional normal distribution will be described below.

The trajectory generator 505 generates a predicted trajectory with an input of the sampled latent variables. The number of times of random sampling performed by the sampling unit 504 (the number of latent variables) is the number of predicted trajectories output by the trajectory generator 505.

By inputting the spatiotemporal features obtained by the spatiotemporal feature integration unit 503 and the latent variables obtained by the sampling unit 504 as input data, the trajectory generator 505 outputs predicted trajectories. The trajectory generator 505 generates the predicted trajectory for each of latent variables. The trajectory generator 505 may be assigned to each of one or more latent variables, and each of the trajectory generators 505 may perform trajectory prediction for the corresponding latent variable.

For example, the trajectory generator 505 obtains a predicted trajectory using a neural network that inputs the above input data and outputs the predicted trajectory. Since both the spatiotemporal features and latent variables are one-dimensional vectors, it is possible to use a neural network that inputs input data in which these vectors are concatenated in the dimensional direction and outputs the predicted trajectory.

The neural network used by the trajectory generator 505 includes a recurrent neural network and a fully connected layer, for example. The recurrent neural network repeats arithmetic operations at each of time steps until a designated predicted time is reached. The input of the recurrent neural network at each of time steps is the same input data concatenating spatiotemporal features and latent variables. Internal variables in the recurrent neural network are updated sequentially by performing iterative operations.

The output from the fully connected layer of the recurrent neural network at each of time steps is either a coordinate value representing a future position or information representing a distribution of the future position. The coordinate value representing the position is two-dimensional information including an x coordinate value and a y coordinate value, for example. The information representing the distribution of positions is a total of five-dimensional information including two-dimensional coordinate values representing the peaks of positions, two-dimensional values representing variances, and one-dimensional value representing a correlation coefficient.

With iterative operations performed for each of time steps until the designated predicted time is reached, the set of future predicted positions will form one predicted trajectory. The trajectory generator 505 performs such an operation for each of latent variables and generates predicted trajectories for the number of latent variables.

So far, the functions provided by the predictor 105 have been described separately for individual units (time-series feature extraction unit 501, spatial feature extraction unit 502, spatiotemporal feature integration unit 503, sampling unit 504, trajectory generator 505). Alternatively, some or all of these functions may be integrated. For example, one neural network integrating the neural networks used by individual units may be used as a neural network for trajectory prediction performed by the predictor 105.

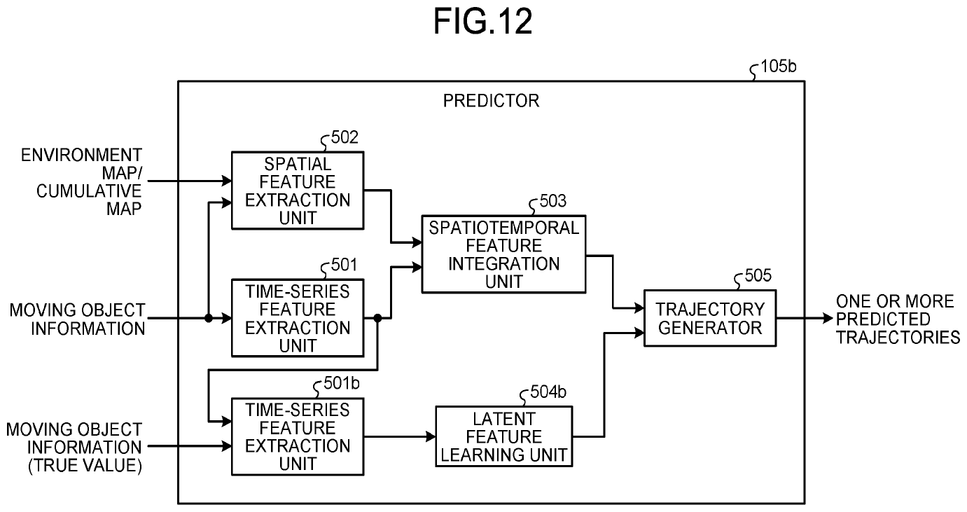

Next, a learning method to be applied to the neural network used by the predictor 105, provided by the learning unit 106, will be described. FIG. 12 is a block diagram illustrating a detailed functional configuration example of the predictor (hereinafter referred to as a predictor 105b) at the time of learning. As illustrated in FIG. 12, the predictor 105b includes time-series feature extraction units 501 and 501b, a spatial feature extraction unit 502, a spatiotemporal feature integration unit 503, a latent feature learning unit 504b, and a trajectory generator 505. The same components as those used at the time of inference are indicated by the same reference numerals and description thereof will be omitted.

The time-series feature extraction unit 501b inputs a true value of moving object information (a true value of a trajectory of a moving object), and outputs a time-series feature corresponding to the true value of the moving object information. The true value of the moving object information is data as a result of acquisition, for one time point, of a one-dimensional vector including at least one of the position, angle, speed, angular velocity, acceleration, and angular acceleration of the moving object at a future time point. For example, after sequentially inputting moving object information to the time-series feature extraction unit 501, by performing inputting the true value to the recurrent neural network of the time-series feature extraction unit 501b having the same weight as the recurrent neural network of the time-series feature extraction unit 501, it is possible to extract time-series features of the trajectory corresponding to the true value.

By using a neural network, the latent feature learning unit 504b learns a multidimensional normal distribution of one or more dimensions so as to approximate the time-series features of the trajectory corresponding to the true value. The neural network inputs the time-series features of the trajectory corresponding to the true value into the fully connected layer and performs outputs separately for the mean and variance of one dimension or more. A loss indicating the error between the distribution expressed by the mean and variance and the multidimensional normal distribution will be added to the loss function of the learning. This makes it possible to obtain a multidimensional normal distribution that approximates the time-series features of the trajectory equivalent to the true value. The loss indicating the error between distributions can be represented by a KL Divergence distance, for example.

The latent feature learning unit 504b uses a Reparameterization trick, for example, to generate a latent feature to be input to the trajectory generator 505. When the mean generated by the latent feature learning unit 504b is μ and the variance is Σ, the latent variable can be expressed by the following formula (1).

μ=√Σ×N(0,I) (1)

where I is the identity matrix. N (0, I) represents random sampling within a multidimensional normal distribution with mean μ=0 and variance Σ=1. This configuration makes it possible to achieve learning using backpropagation of latent variables.

The learning unit 106 provides learning so as to minimize the loss function. The loss function includes, in addition to the loss between the above distributions (such as the KL Divergence distance), a loss (loss of the predicted trajectory) indicating the error between the predicted trajectory generated by the trajectory generator 505 and the true value trajectory.

For example, in a case where the output of the trajectory generator 505 is information representing the distribution of positions (such as a two-dimensional normal distribution), the loss of the predicted trajectory is designed so as to maximize (minimize when a negative sign is put) the probability that the position of the true value (true value position) exists within the distribution (two-dimensional normal distribution or the like) represented by the future position, variance, and correlation coefficient output at individual time steps. Furthermore, in a case where the output of the trajectory generator 505 is a coordinate value representing a position, the loss of the predicted trajectory is designed so as to minimize an absolute error or the square error between the output coordinate value and the true value position.

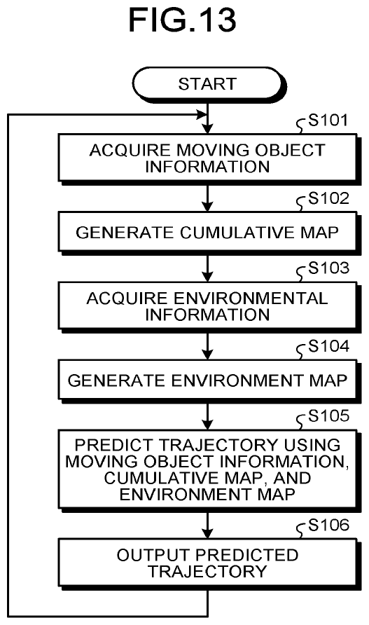

Next, a flow of the prediction process performed by the prediction device 40 according to the present embodiment configured in this manner will be described. FIG. 13 is a flowchart illustrating an example of the prediction process according to the present embodiment.

The moving object information acquisition unit 101 acquires moving object information from the sensor device 24 or the like (Step S101). The cumulative map generator 104 generates a cumulative map using the acquired moving object information (Step S102). The processes of Steps S101 and S102 are executed at a plurality of time points until the reference time point is reached.

The environmental information acquisition unit 102 acquires environmental information using the information obtained from the sensor device 24 (Step S103). The environment map generator 103 generates an environment map using the moving object information and the environmental information acquired at the reference time point (Step S104).

The predictor 105 predicts the trajectory of the moving object by using the moving object information acquired at the reference time point, the cumulative map generated up to the reference time point, and the environment map generated at the reference time point (Step S105). The predictor 105 outputs the predicted trajectory obtained by the prediction (Step S106). Thereafter, the process returns to Step S101 and the process will be repeated.

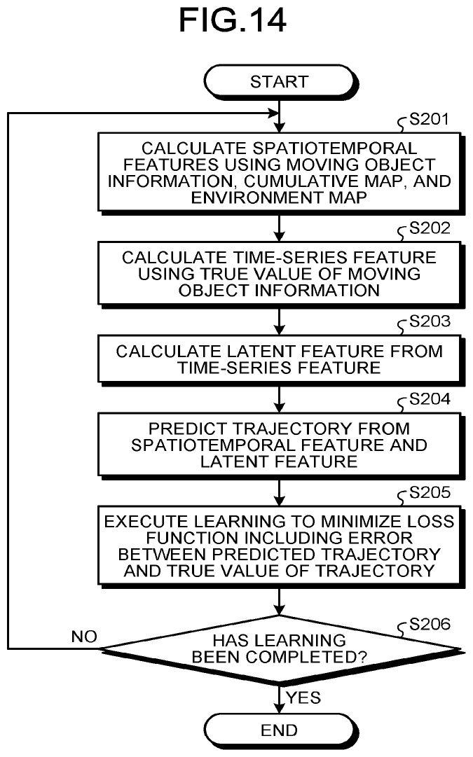

Next, a flow of the learning process performed by the prediction device 40 according to the present embodiment configured in this manner will be described. FIG. 14 is a flowchart illustrating an example of the learning process in the present embodiment.

The predictor 105b (time-series feature extraction unit 501, spatial feature extraction unit 502, and spatiotemporal feature integration unit 503) used in the learning calculates spatiotemporal features using moving object information, a cumulative map, and an environment map (Step S201). Furthermore, the predictor 105b (time-series feature extraction unit 501b) calculates the time-series feature using the true value of the moving object information (Step S202).

The predictor 105b (latent feature learning unit 504b) calculates the latent feature from the time-series feature calculated in Step S202 (Step S203). The predictor 105b predicts a trajectory from the spatiotemporal feature calculated in Step S201 and the latent feature calculated in Step S203 (Step S204).

The learning unit 106 executes a learning process so as to minimize the loss function including a loss indicating an error between the predicted trajectory and the true value of the trajectory, a loss indicating an error between distributions (Step S205). The learning unit 106 determines whether the learning is completed (Step S206). For example, the learning unit 106 determines the end of learning based on whether the magnitude of the improvement in loss is smaller than a threshold and whether the number of times of learning has reached an upper limit value.

In a case where the learning is not completed (Step S206: No), the process returns to Step S201 and the process is repeated for new training data. When it is determined that the learning is completed (Step S206: Yes), the learning process ends.

In this manner, in the present embodiment, a cumulative map indicating an area in which a plurality of moving objects are likely to pass is generated only from the information obtained from the sensor, and the trajectory of the moving object is predicted using the generated cumulative map. This makes it possible to predict the future position of the moving object with higher accuracy without using a high-precision map or the like, which has a large processing load for generation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A prediction device comprising:
one or more hardware processors configured to:
acquire moving object information indicating positions of one or more moving objects including a first moving object to be predicted;
generate cumulative map information expressing, on a map, a plurality of the positions indicated by the moving object information acquired at a plurality of first time points equal to or earlier than a reference time point; and
predict a position of the first moving object at a second time point later than the reference time point based on environment map information expressing, on a map, an environment around the first moving object at the reference time point, the moving object information acquired at the reference time point, and the cumulative map information.

2. The prediction device according to claim 1, wherein
the one or more hardware processors generate the cumulative map information for which at least one of a movement amount of the moving object, a speed of the moving object, and a movement direction of the moving object is associated with each of the plurality of positions indicated by the moving object information acquired at the plurality of first time points.

3. The prediction device according to claim 1, wherein
the one or more hardware processors generate the cumulative map information for which at least one of a mixture distribution of movement amounts of the plurality of moving objects, a mixture distribution of speeds of the plurality of moving objects, and a mixture distribution of movement directions of the plurality of moving objects is associated with each of the plurality of positions indicated by the moving object information acquired at the plurality of first time points.

4. The prediction device according to claim 1, wherein
the moving object information further includes at least one of an orientation of the moving object, a speed of the moving object, acceleration of the moving object, an angular velocity of the moving object, angular acceleration of the moving object, a moving direction of the moving object, and identification information of the moving object.

5. The prediction device according to claim 1, wherein
the one or more hardware processors are configured to:
acquire environmental information indicating an environment around the first moving object; and
generate the environment map information based on the environmental information and the moving object information.

6. The prediction device according to claim 5, wherein
the environment map information includes at least one of obstacle map information indicating presence or absence of an obstacle, attribute map information indicating attributes of the environment, and route map information indicating a route on which the first moving object is to travel.

7. The prediction device according to claim 6, wherein
the route map information includes one of reward map information indicating a reward for an action that the first moving object is to take, which is calculated by a neural network having at least one of the obstacle map information and the attribute map information as an input; and policy map information indicating a policy that the first moving object is to take based on the reward.

8. The prediction device according to claim 5, wherein
the environmental information includes at least one of an obstacle, a road, a walking path, a curb, a sign, a traffic light, and road marking.

9. The prediction device according to claim 1, wherein
the one or more hardware processors predict the position of the first moving object by using a neural network having the environment map information, the moving object information, and the cumulative map information, as an input.

10. The prediction device according to claim 9, wherein
the neural network predicts one or more positions for each of one or more variables sampled based on a multidimensional normal distribution that characterizes a trajectory of a moving object.

11. The prediction device according to claim 1, wherein
the one or more hardware processors predict the position of the first moving object at the second time point by using the environment map information to which a weight is assigned in accordance with a value set in the cumulative map information.

12. A prediction method implemented by a computer, the method comprising:
acquiring moving object information indicating positions of one or more moving objects including a first moving object to be predicted;
generating cumulative map information expressing, on a map, a plurality of the positions indicated by the moving object information acquired at a plurality of first time points equal to or earlier than a reference time point; and
predicting a position of the first moving object at a second time point later than the reference time point based on environment map information expressing, on a map, an environment around the first moving object at the reference time point, the moving object information acquired at the reference time point, and the cumulative map information.

13. A computer program product having a non-transitory computer readable medium including programmed instructions, wherein the instructions, when executed by a computer, cause the computer to perform:
acquiring moving object information indicating positions of one or more moving objects including a first moving object to be predicted;
generating cumulative map information expressing, on a map, a plurality of the positions indicated by the moving object information acquired at a plurality of first time points equal to or earlier than a reference time point; and
predicting a position of the first moving object at a second time point later than the reference time point based on environment map information expressing, on a map, an environment around the first moving object at the reference time point, the moving object information acquired at the reference time point, and the cumulative map information.

14. A vehicle control system adapted to control a vehicle, the vehicle control system comprising:
a prediction device that predicts a position of a first moving object to be predicted; and
a vehicle control device that controls a drive mechanism for driving a vehicle based on the predicted position, wherein
the prediction device comprises:
one or more hardware processors configured to:
acquire moving object information indicating positions of one or more moving objects including a first moving object to be predicted;
generate cumulative map information expressing, on a map, a plurality of the positions indicated by the moving object information acquired at a plurality of first time points equal to or earlier than a reference time point; and
predict a position of the first moving object at a second time point later than the reference time point based on environment map information expressing, on a map, an environment around the first moving object at the reference time point, the moving object information acquired at the reference time point, and the cumulative map information.
